(19) United States
(12) Patent Application Publication
(10) Pub. No.: US 2013/0020344 A1
(43) Pub. Date: Jan. 24, 2013

(54) EAR PROTECTION DISPENSER

(71) Applicant: MMEAR Tech, LLP, Pittsburgh, PA (US)

(72) Inventors: Marilyn J. MANCE, Pittsburgh, PA (US); Frank R. MANCE, Pittsburgh, PA (US)

(73) Assignee: MMEAR TECH, LLP, Pittsburgh, PA (US)

(21) Appl. No.: 13/633,237

(22) Filed: Oct. 2, 2012

Related U.S. Application Data
(63) Continuation-in-part of application No. 12/719,963, filed on Mar. 9, 2010, now Pat. No. 8,281,791.
(60) Provisional application No. 61/209,977, filed on Mar. 13, 2009.

(51) Int. Cl. B65H 3/00; B23P 17/04

(52) U.S. Cl. 221/1; 29/428; 221/26

(57) ABSTRACT

A dispensing system, a method of using a dispensing system, and a method of making a dispensing system are disclosed. The dispensing system includes a sheet and one or more of the plurality of the ear protection articles positioned on the sheet. The method of using the dispensing system includes removing one or more of the plurality of the ear protection articles from a sheet of the dispensing system. The method of making the dispensing system includes positioning a sheet, positioning a first article of the plurality of the ear protection articles on the sheet, and positioning a second article of the plurality of the ear protection articles on the sheet.

### CROSS-REFERENCE TO RELATED APPLICATIONS

This application is a continuation-in-part of, and claims priority to, U.S. patent application Ser. No. 12/719,963 having a filing date of Mar. 9, 2010, which claims priority to U.S. Provisional Patent Application No. 61/209,977 filed Mar. 10, 2010, both of which are hereby incorporated by reference in their entirety.

### FIELD OF THE INVENTION

The present invention is directed to ear protection dispensing methods and systems. More specifically, the present invention is directed to dispensing with one or more of a plurality of ear protection articles positioned thereon.

### BACKGROUND OF THE INVENTION

In general, known ear protection can be in the form of an earplug or an ear muff (for example, a head-phone). The earplugs are inserted into the ear canal of an ear. The earplugs can include a narrower internal portion for insertion into the ear canal and a wider external portion. The wider external portion can be secured by urging a tragus of the ear away from the ear canal. As these earplugs are in contact with the ear canal, these earplugs can result in foreign objects (for example, oil, dirt, water, and/or bacteria) being introduced into the ear canal. These earplugs suffer from the drawback that they can be uncomfortable. For example, sleeping with the head positioned on its side can result in pressure upon the ear canal. Also, repetitive use of these earplugs may increase risk of infection. Furthermore, these earplugs can be ineffective in certain environments. For example, known earplugs are rated below a noise reduction rating (NRR) of 33. As used herein, the term “noise reduction rating” or “NRR” refers to ANSI S3.19-1974, “American National Standard for the Measurement of Real-Ear Hearing Protector Attenuation and Physical Attenuation of Earmuffs,” specified by 40 C.F.R., Pt. 211, Product Noise Labeling, Subpart B—Hearing Protection Devices. In terms of availability, these ear plugs are typically dispensed in individually packaged pairs, and the bulky design does not lend itself to small, compact packaging of multiple pairs of ear plugs.

In general, ear muffs include a large generally circular geometry for covering the entire ear. These ear muffs are large, can be uncomfortable, and can involve complex electronics. The size and shape of these ear muffs prevents comfortable use for sleeping, are visually unappealing, and can be expensive due to the amount of material necessary to effectively protect the ear. In general, known ear muffs are rated below a noise reduction rating of 33. In addition, ear muffs having noise reduction ratings above noise reduction rating 25 can cost hundreds of dollars. Further, these ear muffs are large devices where the bulky design does not lend itself to small, compact packaging of multiple pairs of ear muffs.

A method and system for dispensing ear protection articles that does not suffer from one or more of the above drawbacks would be desirable in the art.

### SUMMARY OF THE INVENTION

In an exemplary embodiment, a dispensing system for dispensing a plurality of ear protection articles includes a sheet and one or more of the plurality of the ear protection articles positioned on the sheet.

In another exemplary embodiment, a method of using a dispensing system for dispensing a plurality of ear protection articles includes removing one or more of the plurality of the ear protection articles from a sheet of the dispensing system.

In another exemplary embodiment, a method of making a dispensing system for dispensing a plurality of ear protection articles includes positioning a sheet, positioning a first article of the plurality of the ear protection articles on the sheet, and positioning a second article of the plurality of the ear protection articles on the sheet.

An advantage of embodiments of the present disclosure includes protecting an ear from noise or external objects.

Another advantage of embodiments of the present disclosure includes reducing the intensity of sound audible to the ear.

Another advantage of embodiments of the present disclosure includes improved comfort in comparison to known techniques for protecting an ear from noise or external objects.

Another advantage of embodiments of the present disclosure includes increased effectiveness of reducing sound or preventing the entry of foreign objects.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an exemplary embodiment of a protective ear article secured to an ear.

FIG. 2 shows a cross section of FIG. 1 along line 2-2.

FIG. 3 shows a top view of an exemplary embodiment of a plurality of protective ear articles positioned on a sheet.

FIG. 4 shows a side view of an exemplary embodiment of a dispensing system.

### DETAILED DESCRIPTION OF THE INVENTION

Provided is an exemplary ear protection article dispensing system, method of using an ear protection article dispensing system, and method of making an ear protection article dispensing system. Embodiments of the present disclosure provide a small, compact dispenser to dispense packaging of multiple pairs of ear protection articles. The ear protection articles protect the ear from noise or external objects. The ear protection articles reduce the intensity of sound audible to an individual using the article and/or prevent foreign objects from entering an ear canal of the ear.

Embodiments of the present disclosure can protect an ear from noise or external objects, can reduce the intensity of sound audible to the ear, can improve comfort in comparison to known techniques for protecting an ear from noise or external objects, and/or can increase effectiveness of reducing sound or preventing the entry of foreign objects.

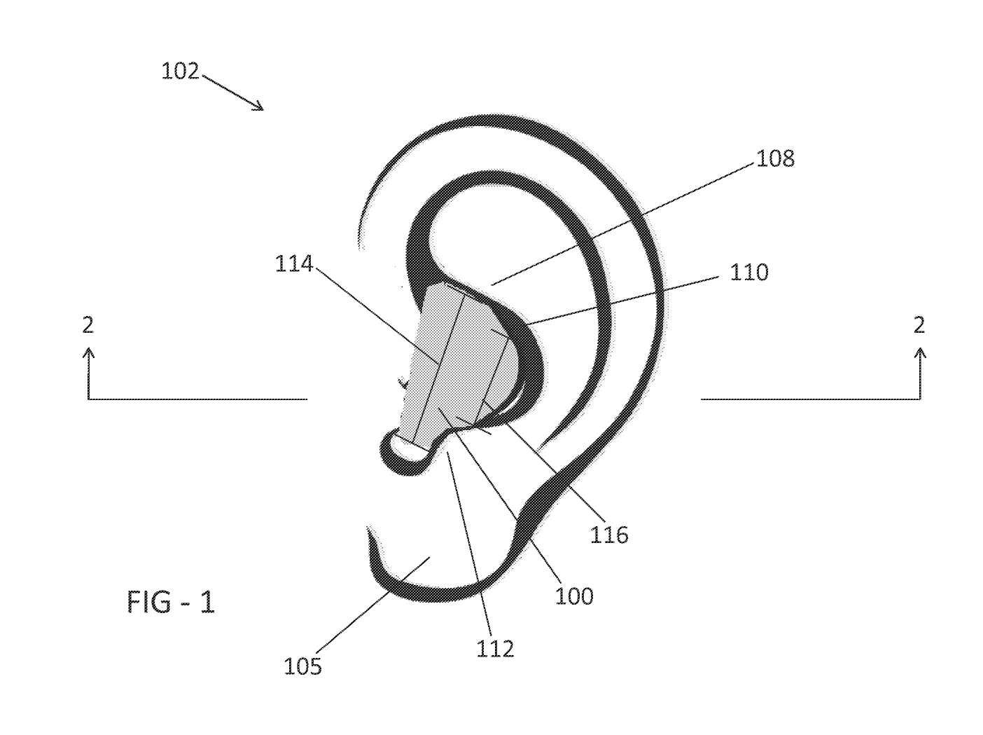

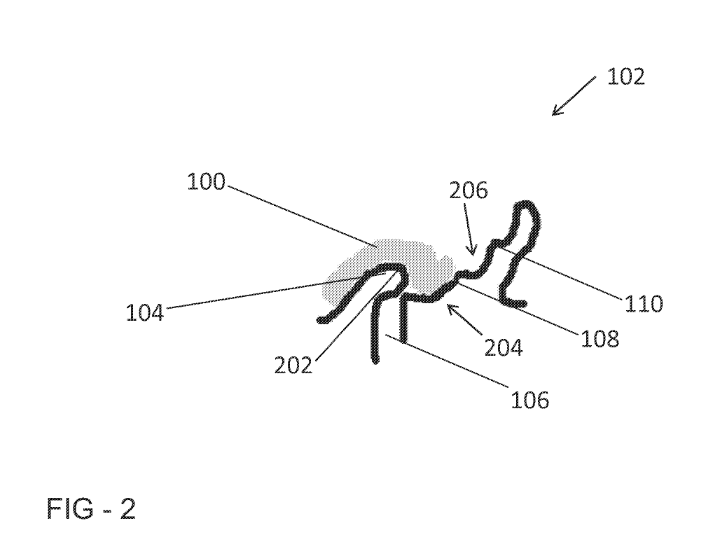

FIG. 1 shows an ear protection article 100 for ear protection positioned within an ear 102. The ear 102 shown in FIG. 1 includes a tragus 104 (see FIG. 2), an ear canal 106 (see FIG. 2), an antihelix 108, a concha 110, and an antitragus 112. The tragus 104 is a flap of cartilage in the outer ear extending away from the ear canal in its natural resting position. The antihelix 108 is a rounded piece of cartilage inside the outer rim (or helix) of the ear. The concha 110 is a recess in the outer ear bordering the antihelix 108. The antitragus 112 is cartilage in the outer ear bordering an ear lobe 105. The antitragus 112 and the concha 110 form a first region 204 (see FIG. 2). As shown in FIG. 2, in one embodiment, a portion of the ear protection article 100 is configured to be removably secured within the first region 204. The antitragus 112 and the antihelix 108 form a second region 206. In another embodiment, a portion of the ear protection article 100 is configured to be removably secured within the second region 206.

Referring again to FIG. 1, the ear protection article 100 prevents the introduction of foreign objects into the ear 102 and/or reduces the intensity of sound audible to the individual using the ear protection article 100 by being positioned and removably secured according to a method of the disclosure. The ear protection article 100 can permit use of the ear protection article 100 while sleeping without resulting in substantial pressure upon the ear canal 106 while the individual using the ear protection article 100 rests on the ear 102. The ear protection article 100 includes a first dimension 114 and a second dimension 116. The first dimension 114 is large enough to cover the tragus 104. The ear protection article 100 can include rounded edges permitting the article to conform to geometry of the ear 102. In one embodiment, the geometry of the ear protection article 100 permits use of the ear protection article 100 by substantially all individuals having an ear 102 including the tragus 104 and the ear canal 106. In another embodiment, the geometry of the ear protection article 100 can permit use of the ear protection article 100 by substantially all individuals having an ear 102 including the tragus 104, the ear canal 106, the antitragus 112, and the antihelix 108. As shown in FIG. 1, the second dimension 116 is configured to be removably secured within the first region 204 formed by the antitragus 112 and the concha 110. For example, the second dimension is small enough to be secured within the first region 204. In another embodiment, the second dimension 116 is configured to be removably secured within the second region formed by the antitragus 112 and the concha 110. For example, the second dimension 116 is small enough to be secured within the second region 206. The ear protection article 100 can include other suitable sizes, configurations, and/or geometries.

As shown in FIG. 2, the ear protection article 100 includes a surface 202 configured for securing the ear protection article 100 to the tragus 104 and urging the tragus 104 to at least partially cover the ear canal 106, thereby protecting the ear 102. Upon securing the ear protection article 100 to the tragus 104, the tragus 104 is urged to at least partially cover the ear canal 106. In one embodiment, upon being removably secured, the ear protection article 100 urges the tragus 104 to abut the ear canal 106. In one embodiment, the ear protection article 100 completely seals the ear canal 106 from the passage of air, water, or other foreign objects. In this embodiment, the ear protection article 100 is configured for swimming or other underwater or in-water activities. In a further embodiment, the ear protection article 100 urges the tragus 104 to completely seal the ear canal 106. In one embodiment, the ear protection article 100 is shaped and configured to be conformable to the shape of the ear 102, and to urge the tragus 104 to at least partially cover the ear canal 106. The ear protection article 100 is adapted to overlay the tragus 104 without contacting the ear canal 106 when secured to the ear 102.

At least a portion of the surface 202 includes an adhesive configured to removably secure the ear protection article 100 upon the tragus 104 being urged to at least partially cover the ear canal 106. The adhesive can directly adhere the ear protection article 100 to skin within the ear 102. Surface preparation of the skin to prepare a surface of the ear 102 to receive the ear protection article 100 can include cleaning (for example, with soap, water, and/or isopropyl alcohol, etc). The adhesive can be any suitable adhesive. In one embodiment, the adhesive can be a hypoallergenic adhesive. In another embodiment, the adhesive can be water-proof. In a further embodiment, the adhesive can form a water-proof seal permitting the ear protection article 100 to substantially prevent water from entering the ear canal 106. In another embodiment, the adhesive can be limited to materials generally recognized as safe or known to be safe on human skin. The adhesive can be configured to be removed by a liquid and/or by being pulled off. In one embodiment, the adhesive can be configured to resist detachment when exposed to force corresponding to a tendency of the tragus 104 to relax to a natural resting position. Additionally or alternatively, the adhesive can be configured to detach at a predetermined application of force less than a predetermined amount of force capable of causing injury upon removal of the ear protection article 100.

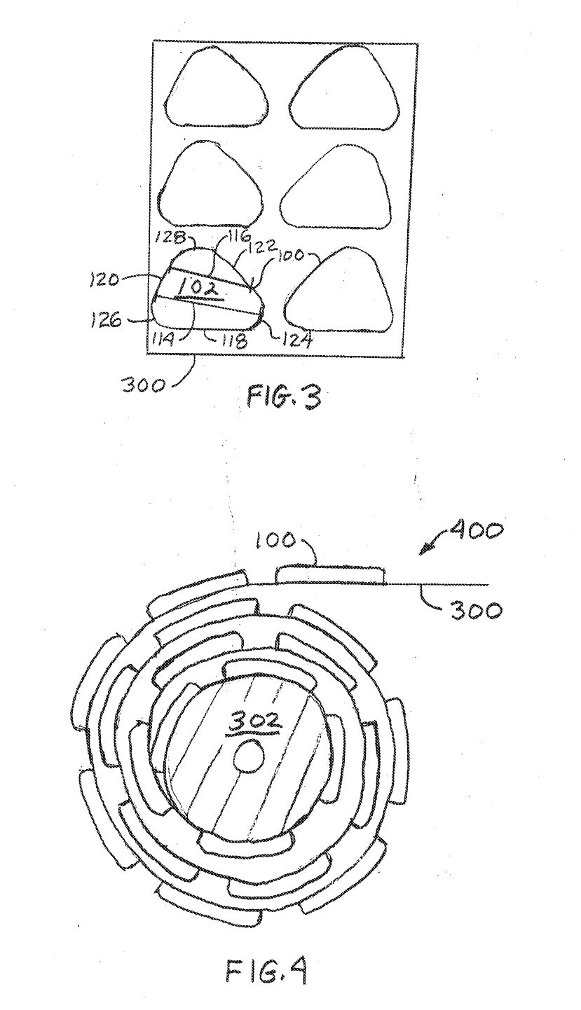

Referring to FIG. 3, in one embodiment, the ear protection article 100 is a generally planar polygon having a first side 118, a second side 120, a third side 122, a rounded corner 124 disposed between the first side 118 and the third side 122, a rounded corner 126 disposed between the first side 118 and the second side 120, and a rounded corner 128 disposed between the second side 120 and the third side 122.

The ear protection articles 100 are capable of being positioned on a sheet 300. In one embodiment, the sheet 300 includes ear protection articles 100 configured for use in a right side ear, and ear protection articles 100 configured for use in a left side ear. The first dimension 114 of the ear protection article 100 is measured linearly from a point located approximately at the apex of the rounded corner 124 to a point on the second side 120 located approximately a third of the length of the second side 120 extending away from the rounded corner 126. In one embodiment, the first dimension 114 is between about 1.0 inch to about 1.375 inches, between about 1.125 inches to about 1.25 inches, between about 1.125 inches to about 1.375 inches, or any suitable range or sub-range therein. Additionally or alternatively, the second dimension 116 of the ear protection article 100 is measured linearly from a point on the third side 122 located approximately a third of the length of the third side 122 extending away from the rounded corner 124 to a point on the second side 120, with the second dimension 116 aligned approximately parallel to the first dimension 114. The second dimension 116 is between about 0.5 inch to about 0.875 inch, between about 0.625 inch to about 0.875 inch, between about 0.625 inch to about 0.75 inch, or any suitable range or sub-range therein. In further embodiments, the thickness of the ear protection article 100 is between about 0.0625 inch to about 0.25 inch, between about 0.125 inch to about 0.1875 inch, between about 0.125 to about 0.25 inch, or any suitable range or sub-range therein.

As shown in FIG. 4, in one embodiment, a dispensing system 400 is capable of securing and repositioning/rotating the sheet 300. For example, in this embodiment, the sheet 300 is removably coiled around a rotatable spool 302. Additionally or alternatively, a plurality of the sheets 300 are stacked in layers. The sheets 300 are positioned abutting each other. The dispensing system 400 is any suitable device capable of support of the sheet 300, such as a box, housing, base, receptacle, or container. In one embodiment, the dispensing system 400 is configured for at least partial enclosure of a plurality of the sheets 300 with the one or more of a plurality of the ear protection articles 100, preventing contamination by dirt, dust, bacteria, or biological material.

In one embodiment, the dispensing system 400 is configured for removable attachment of the spool 302 or a plurality of the spools 302. For example, in one embodiment two of the spools 302 are positioned with the spools each corresponding to ear protection articles 100 for a right ear and a left ear, respectively.

The ear protection articles 100 are removably adhered to the sheet 300. At least a portion of the surface 202 of the ear protection article 100 includes an adhesive configured to removably secure the ear protection article 100 to the sheet 300 and after removal from the sheet 300, the adhesive is reusable to adhere the ear protection article 100 to the ear 102 (see FIGS. 1 and 2). In another embodiment, an additional sheet (not shown) is removably adhered to each of the ear protection articles 100, for removal prior to placement of the ear protection article 100 on the ear 102.

The sheets 300 include any suitable features, such as, perforation lines, tear gaps, or thin material for tearing apart, graphics, logos, or indicia for placement assistance in securing to the ear 102, features to improve gripping, or sound protection, such as texturing, ridges, or protrusions.

The ear protection article 100 can include any material capable of manipulation and capable of conforming to the shape of the ear 102. In one embodiment, the ear protection article 100 includes or is polyvinyl chloride foam. Other suitable polymeric materials can be additionally or alternatively included. For example, the ear protection article 100 may include or be polyurethane foam, moldable silicon, moldable wax, other suitable materials, or combinations thereof. The material of the ear protection article 100 may be selected to further reduce intensity of sound audible to the individual using the ear protection article 100. In one embodiment, the material provides sound intensity reduction of at least 20 decibels. In another embodiment, the material and the positioning of the ear protection article 100 provides sound intensity reduction of at least 40 decibels. In this embodiment, a portion of the sound intensity reduction is provided by the urging of the tragus 104 to at least partially cover the ear canal 106.

The Occupational Safety & Health Administration (OSHA) has provided Safety and Health Regulations for Construction regarding hearing protection. Where feasible for noise reduction use, these regulations require ear protective devices to be provided and used (29 CFR 1926.101 (a)-(c)). Methods for estimating the adequacy of hearing protector attenuation involve use of the Noise Reduction Rating (NRR) achieved by the hearing protector (29 CFR 1910.95 App B). In one embodiment, positioning of the ear protection article 100 according to the disclosure can result in a noise reduction rating of 34 without being combined with other articles.

In operation, one embodiment of a method of using the dispensing system 400 includes accessing one or more of a plurality of ear protection articles 100 positioned on a sheet 300, removing one or more of the plurality of ear protection articles 100 from the sheet 300. In a further embodiment, the method includes removably securing the one or more of the plurality of ear protection articles 100 to an ear 102, overlaying the tragus 104 without contacting the ear canal 106 of the ear, and urging the tragus 104 to at least partially cover the ear canal 106.

In operation, one embodiment of a method of making the dispensing system 400 includes positioning the sheet 300, positioning a first set of one or more of the ear protection articles 100 on the sheet 300 (for example, the first set being two of the ear protection articles 100), and positioning a second set of one or more of the ear protection articles 100 on the sheet 300 (for example, the second set being two of the ear protection articles 100). In one embodiment, the first set is positioned, then the sheet 300 is advanced, then the second set is positioned.

The material of the ear protection article 100 can be selected to provide any suitable properties. For example, the material can be waterproof, water-resistant, hypoallergenic, generally recognized as safe, compressible, transparent, translucent, or of a predetermined color (for example, varying shades of skin-toned colors). Additionally or alternatively, the ear protection article 100 can include a design, text, or other indicia. In one embodiment, the material of the ear protection article 100 may be selected to reduce the intensity of sounds having a predetermined frequency. For example, a first material used in the ear protection article 100 can be selected to reduce higher frequency sounds and/or a second material used in the ear protection article 100 can be selected to reduce lower frequency sounds. Furthermore, the amount of material forming the ear protection article 100 can be configured to reduce a predetermined amount of sound audible to the individual using the ear protection article 100.

### EXAMPLES

In a first example, an article having a circular geometry according to the disclosure was positioned over the tragus and removably secured to a region of the ear formed by the anti-tragus of the ear and the antihelix of the ear. The circular article urged the tragus to cover the ear canal. The circular article reduced intensity of sound audible to an individual using the article and prevented foreign objects from entering an ear canal of the ear. The circular article prematurely became unsecured and was unable to be secured to several ear shapes.

In a second example, an article having a rectangular geometry according to the disclosure was positioned over the tragus and removably secured to a region of the ear formed by the anti-tragus of the ear and the antihelix of the ear. The rectangular article urged the tragus to cover the ear canal. The rectangular article reduced intensity of sound audible to an individual using the article and prevented foreign objects from entering an ear canal of the ear. The rectangular article prematurely became unsecured and was unable to be secured to several ear shapes.

In a third example, an article having a generally trapezoidal geometry and rounded corners according to the disclosure was positioned over the tragus and removably secured to a region of the ear formed by the anti-tragus of the ear and the antihelix of the ear. The generally trapezoidal article urged the tragus to cover the ear canal. The generally trapezoidal article reduced intensity of sound audible to an individual using the article by about 45 decibels resulting in a noise reduction rating of 34 when properly positioned, reduced intensity of sound audible to an individual using the article by about 22 decibels when positioned without urging the tragus to cover the ear canal, and prevented foreign objects from entering an ear canal of the ear. The generally trapezoidal article remained secured until being removed and was able to be secured to a greater range of ear shapes.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A dispensing system for dispensing a plurality of ear protection articles, the dispensing system comprising:
a sheet; and
one or more of the plurality of the ear protection articles positioned on the sheet.

2. The dispensing system of claim 1, wherein the dispensing system is configured for receiving and dispensing the sheet.

3. The dispensing system of claim 2, wherein the dispensing system at least partially encloses the plurality of the ear protection articles.

4. The dispensing system of claim 1, wherein the sheet is removably coiled around a rotatable spool of the dispenser system.

5. The dispensing system of claim 4, wherein the dispensing system is configured for removable attachment of the rotatable spool.

6. The dispensing system of claim 4, further wherein the dispensing system comprises a plurality of the rotatable spools.

7. The dispensing system of claim 1, wherein another sheet is positioned abutting the sheet.

8. The dispensing system of claim 7, wherein the dispensing system at least partially encloses a plurality of the sheets.

9. The dispensing system of claim 1, wherein the one or more of the plurality of the ear protection articles is positioned between two or more of the sheets.

10. The dispensing system of claim 9, wherein the two or more of the sheets substantially enclose the one or more of the plurality of the ear protection articles.

11. The dispensing system of claim 10, wherein the one or more packages are configured to be removably detachable from each adjacent package.

12. The dispensing system of claim 1, wherein the one or more of the plurality of the ear protection articles is a generally planar polygon.

13. The dispensing system of claim 1, wherein the one or more of the plurality of the ear protection articles is shaped and configured to be conformable to the shape of an ear.

14. The dispensing system of claim 1, wherein the one or more of the plurality of the ear protection articles is configured to urge a tragus of an ear to at least partially cover an ear canal of the ear.

15. The dispensing system of claim 1, wherein the one or more of the plurality of the ear protection articles includes a first dimension and a second dimension, the first dimension being large enough to cover the tragus of an ear, the second dimension being small enough to be secured within a region formed by an anti-tragus and an antihelix of the ear.

16. The dispensing system of claim 1, wherein the one or more of the plurality of the ear protection articles is configured to overlay the tragus of an ear without contacting the ear canal of the ear when secured to the ear.

17. The dispensing system of claim 1, wherein the one or more of the plurality of the ear protection articles includes at least two of the ear protection articles.

18. The dispensing system of claim 1, wherein the one or more of the plurality of the ear protection articles includes at least three of the ear protection articles.

19. A method of using a dispensing system for dispensing a plurality of ear protection articles, comprising:
removing one or more of the plurality of the ear protection articles from a sheet of the dispensing system.

20. A method of making a dispensing system for dispensing a plurality of ear protection articles, comprising:
positioning a sheet;
positioning a first article of the plurality of the ear protection articles on the sheet; and
positioning a second article of the plurality of the ear protection articles on the sheet.
